(19) United States
(12) Patent Application Publication
(10) Pub. No.: US 2017/0169532 A1
(43) Pub. Date: Jun. 15, 2017

(54) DYNAMIC ESTIMATION OF GEOGRAPHICAL LOCATIONS USING MULTIPLE DATA SOURCES

(71) Applicant: International Business Machines Corporation, Armonk, NY (US)

(72) Inventors: Ana P. Appel, Sao Paulo (BR); Victor F. Cavalcante, Sao Paulo (BR); Vitor L. Faria, Sao Paulo (BR); Kiran Mantripragada, Sao Paulo (BR)

(21) Appl. No.: 14/968,190

(22) Filed: Dec. 14, 2015

(51) Int. Cl. G06Q 50/26; G06N 5/04; G06Q 10/10; G06N 99/00; G06F 17/30; G06Q 50/00

(52) U.S. Cl. CPC G06Q 50/265; G06F 17/3053; G06F 17/30528; G06Q 50/01; G06Q 10/10; G06N 99/005; G06N 5/04

(57) ABSTRACT

Estimating context aware information associated with a geographical location may include receiving information associated with the geographical location from a plurality of different data source. The information may be combined with social media input received via a social media server. User context may be determined. A machine learning algorithm may be executed to determine a plurality of risks associated with the geographic location to the user based on the user context. A ranked list of the plurality of risks may be presented to the user.

### FIELD

The present application relates generally to computers and computer applications, and more particularly to estimating context-aware information associated with geographical locations.

### BACKGROUND

Being aware of imminent or probable events that might occur at geographical locations helps in avoiding misfortunes. Knowing this type of information allows, for example, government agencies and/or other entities may be able to aid the population in avoiding major incidents, for example, in the municipalities, and allow those agencies to provide safe environment to the population, for example, by proactively providing warnings of any risks in specific geographical areas. Insurance companies may also benefit from such information as proactive warning may minimize losses and injuries to their clients.

### BRIEF SUMMARY

A computer-implemented method and system of estimating context aware information associated with a geographical location may be provided. The method, in one aspect, may include receiving information associated with the geographical location from a plurality of different data sources. The method may also include combining the information with social media input received via a social media server. The method may further include receiving a user profile of a user. The method may also include determining user context. The method may further include executing a machine learning algorithm to determine a plurality of risks associated with the geographic location to the user based on the user context. The method may also include presenting a ranked list of the plurality of risks.

A system of estimating context aware information associated with a geographical location, in one aspect, may include one or more hardware processors. One or more of the hardware processors may be operable to receive information associated with the geographical location from a plurality of different data sources. One or more of the hardware processors may be further operable to combine the information with social media input received via a social media server. One or more of the hardware processors may be further operable to determine user context. One or more of the hardware processors may be further operable to execute a machine learning algorithm to determine a plurality of risks associated with the geographic location to the user based on the user context. One or more of the hardware processors may be further operable to present a ranked list of the plurality of risks.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating an overview of a methodology that may estimate geographic location information in one embodiment of the present disclosure.

FIG. 2 is a diagram illustrating a method that may estimate geographic location information in one embodiment of the present disclosure.

FIG. 3 illustrates an example use case for the methodology of the present disclosure in one embodiment.

FIG. 4 illustrates another example of a use case for the methodology of the present disclosure in one embodiment.

FIG. 5 illustrates a schematic of an example computer or processing system that may implement a context-aware location estimation system in one embodiment of the present disclosure.

### DETAILED DESCRIPTION

A method, system and techniques in one embodiment may integrate sensor data and other information to assess information about a geographical location. In one aspect, information may be gathered from many possible distinct sources, and may be used to anticipate or predict information about a geographical location. In one aspect, such anticipation may help in avoiding undesired risks. Information from a diversity of data sources and sensors may be collected, composed and evaluated to assess risks associated with one or more geographical locations.

The method and system in one embodiment may provide for multi-source, context-aware dynamic real-time risk analysis and recommendation. Population-centric and individual-centric risk analysis and recommendation system in one embodiment may be based on context-aware information from multi-source input data. The method and system in one embodiment may consolidate several outputs of systems and/or instances for a risk analysis, for example, related to disasters and user profiles.

In one aspect, data sources may include dynamic sources and/or historical data repositories, examples of which may include but are not limited to, social media such as blogs, microblogs and news, for example, from one or more social media servers; complex networks such as social, business, work, information networks; weather forecasts (e.g., flood) based on historical data, real time weather data, which may be collected by sensors; official media and reports and/or records such as official broadcasted news, records about security issues and occurrences such as accident claims and/or reports and known epidemics, and others; local geo-referred information, including for example, those from electronic sensors; user information; records about incidents in an area, for example, from incident management systems; and other local information.

Evaluations based on up-to-date information may provide precise and helpful resources in making decisions relating to geographical locations where uncertainties such as weather conditions may vary. Such evaluations may be relied on in making specific choices involving locations and/or destinations.

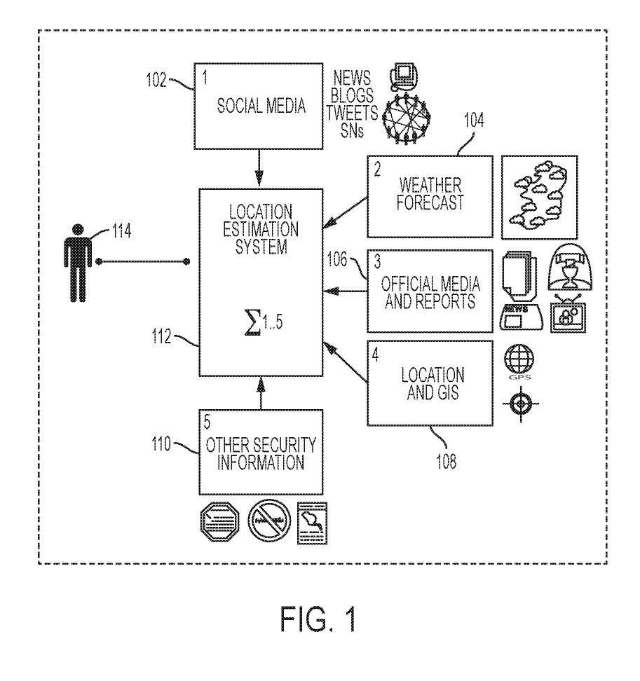

FIG. 1 is a diagram illustrating an overview of a system that may estimate geographic location information in one embodiment of the present disclosure. Information may be received from sources such as social media via a social media or network server 102, weather forecast information from one or more weather servers 104, media or reports from one or more news servers 106, one or more location devices and geographic information system servers 108, and other security information associated with the location 110. A location estimation system or module 112, executing on one or more hardware processors may, for instance, receive real-time information from the different servers 102, 104, 106, 108 and 110, perform analysis to determine or estimate information about a location. The location in one embodiment may be the current location of the user 114, or a location that a user inputs, for instance, as a destination location. For instance, the system with the user's permission may monitor the user's location. In another aspect, the user 114 may input a location to query the system about a specific region.

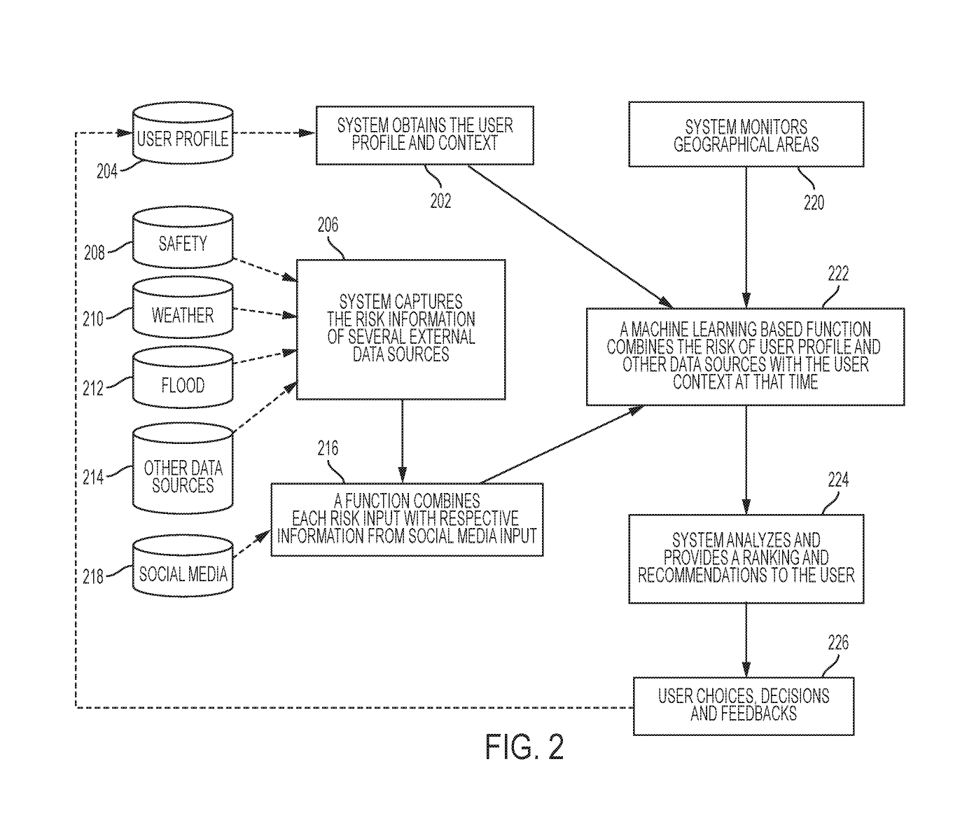

FIG. 2 is a diagram illustrating a method that may estimate geographic location information in one embodiment of the present disclosure. At 202, a user profile information and context 204 may be obtained. The user profile contains, for example, user preferences, user information, visited places, any kind of information that may describe a user and places that user usually goes, for example, as input or permitted by the user to have access of. This information may be obtained smart phones or the like, sensor devices, wearable devices, social media, internal database of entities, and others, for example, as authorized or permitted by the user or appropriate entity. At 206, information from data sources may be obtained. Examples of data sources may include safety information 208, weather data 210, flooding information 212, and other information 214. Such information may be received by communicating with a respective server that manages and stores the respective information.

At 216, social media data 218, for example, from a social media server, may be received related to the geographic location and combined with the information received at 206. For instance, a machine learning algorithm executed on one or more hardware processors may combine information of social media reported by social media users with other data sources obtained in 206.

The system monitors the user steps or the user can query the system about a specific region, the system analyses several data sources using real-time information such as user profile and context, social media and network, weather system and other security database and official media and reports.

At 220, the area of the geographic location may be monitored. For example, the monitoring may be based on social media, global positioning system (GPS) capability or functionality in user device (e.g., a smart phone or the like), news information. A monitoring device may be a computer server, a sensor from an internet of things (IOT) network, and/or a device built specific for monitoring a geographic location.

At 222, a machine learning function executing on one or more hardware processors combines the risk of user profile and other data sources with the user context at that time. For instance, supervised learning implementing one or more of decision trees, support vector machines, neural networks, case based reasoning, k-nearest neighbor, unsupervised learning implementing self-organizing maps, k-means, expectation maximization, statistic-based learning implementing logistic regression, Naive Bayes, discriminant analysis, isotonic separation, and other techniques such as genetic algorithms, group method, fuzzy sets, rules-based learning may be used.

At 224, the method may analyze the machine learning output and provide a ranking and recommendation to the user. For instance, the machine learning algorithm may classify geographical locations according to different levels of riskiness based on the captured data. For instance, the output may include a ranked list of places to avoid or to visit, parking lots to avoid or stop, walking path and time to use this path or avoid. For instance, feedback or an alert may be provided for the user about the geographic location, for example, a possible risk of that region associated with a specific subject such as flooding or safety. For example, consider the user context information such as the type of a vehicle the user is currently driving or using, an assessment may be provided as to the chances or probability that the user might have regarding a flooding problem or a safety problem, if the user were to be at the region at a defined time or current time. Context information may also include the activity of the user (e.g., returning from work, walking) at the time while in the specific region, which may be considered for providing the risk information associated with the region to the particular user. For instance, the methodology may allow a user to check whether the region is safe for parking or walking. In another aspect, entities such as an automobile insurance company or travel related company may utilize the methodology to send a warning message (for example SMS warning) or another alert in real-time about the geographic region to the user. In this way, the user may be warned of possible risks at the geographic location such as natural disaster, epidemics, weather related risks, or others.

At 226, the user may make a choice based on the recommendation and also provide a user feedback as to whether the automatic assessment of the geographic location is correct.

Exiting system that may estimate risks of a specific disaster cause of an area and use algorithms tuned for one specific disaster occurrence. The output of those existing systems may be input to a methodology of the present disclosure and combined or integrated to provide a context aware dynamic estimation of geographical location information.

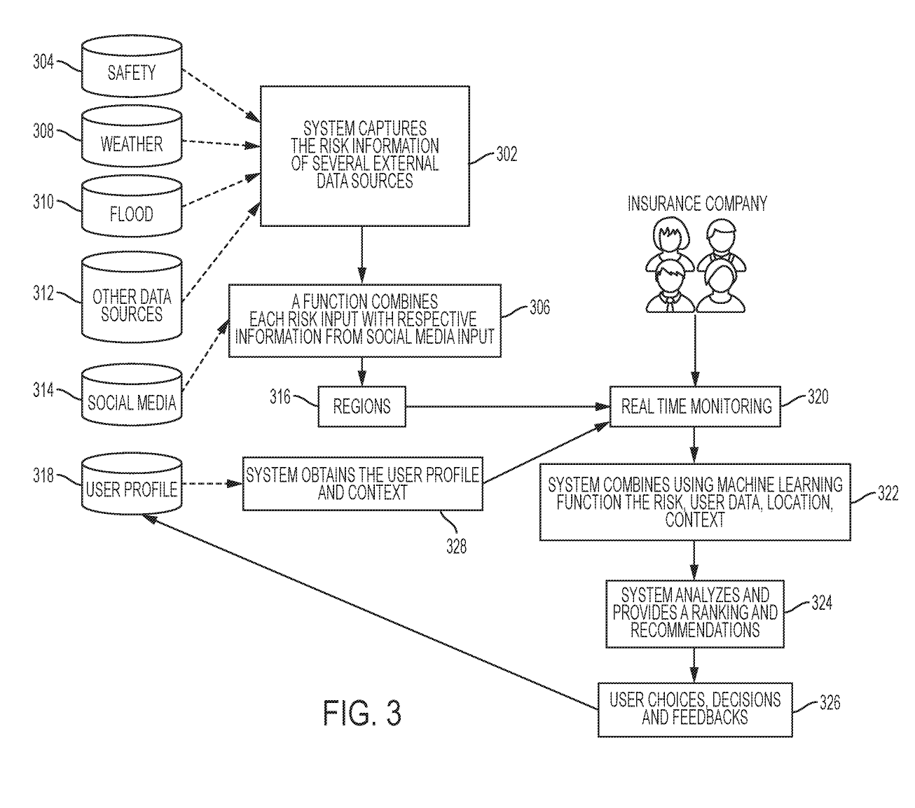

FIG. 3 illustrates an example use case for the methodology of the present disclosure in one embodiment. As described with reference to FIG. 2, one or more hardware processors or a system or module running on one or more hardware processors at 302 may capture risk information associated with a location from a plurality of sources 304, 308, 310, 312. At 306, a function running on one or more hardware processors may combine the captured risk information with respective social media 314 data, for example, received from a social media server and information about the geographical location or region 316 is generated. A machine-learning algorithm may combine information of social media reported by social media users with other data sources captured at 302. In one embodiment, each source may have different weight in contributing its data in generating overall information about the geographical location.

At 328, user profile and context 318 may be obtained associated with a user, for whom dynamic context-aware geographical location estimation is being determined.

At 320, real time monitoring function running on one or more processors may receive the user profile and context information 318 and the combined information about the geographical region 316 captured from multiple diverse sources. Real time information, for example, may be monitored using social media, a global positioning system (GPS) device or functionality in a user device (e.g., a smart phone or the like) and news information. Real time monitoring at 320 may be performed by a computer server, a sensor from an internet of things (IOT) network, and/or a device built specifically for monitoring a geographic location.

The real time information function may be invoked, for example, from an enterprise's computer system, for example, an insurance company that may want to assess risk estimation about a geographical location.

At 322, one or more hardware processors runs a machine learning function and combines the risk information obtained at 306, user data, location and context. For instance, supervised learning implementing one or more of decision trees, support vector machines, neural networks, case based reasoning, k-nearest neighbor, unsupervised learning implementing self-organizing maps, k-means, expectation maximization, statistic-based learning implementing logistic regression, Naive Bayes, discriminant analysis, isotonic separation, and other techniques such as genetic algorithms, group method, fuzzy sets, rules-based learning may be used.

At 324, analysis may be performed, and risk information associated with the specific region or geographical location as applied to the user and the context (e.g., current context), may be ranked and recommended. For instance, the output from analysis may be a ranked list of places to avoid or to visit, parking lots to avoid or stop, walking path and time to use this path or avoid. Another example of a recommendation may be a list of places to visit or are determined to be safe to visit.

At 326, user may make a decision based on the recommendations. A user may also provide feedback, for example, as to whether the recommendation was correctly based. For example, a user interface module may be presented that allows the user to input feedback information, which may be stored as part of a user profile.

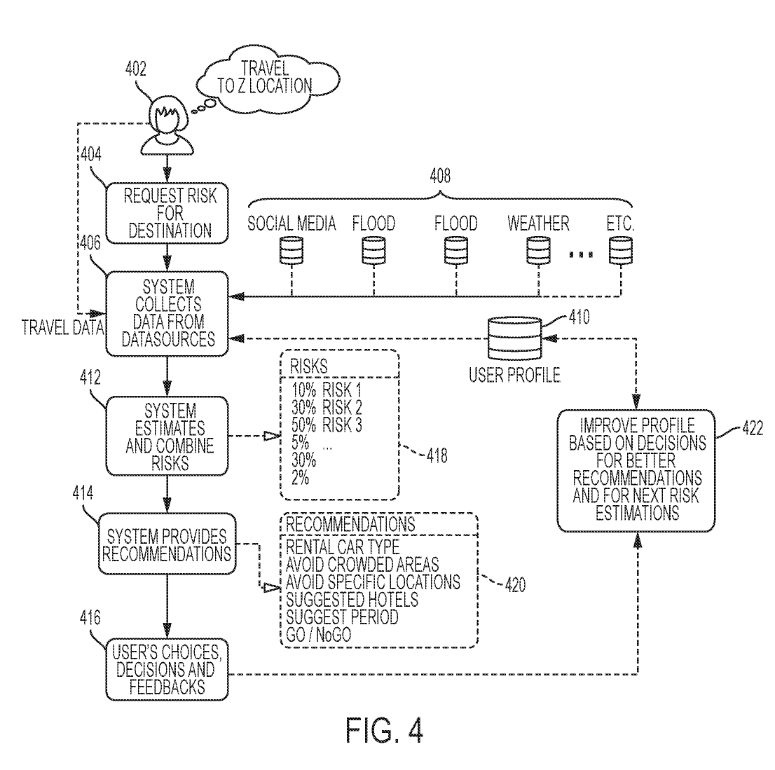

FIG. 4 illustrates another example of a use case for the methodology of the present disclosure in one embodiment. At 402, a user may be interested in traveling to Z location, and 404 requests dynamic assessment for the destination location. At 406, one or more hardware processors implementing a methodology of the present disclosure in one embodiment may obtain data from a plurality of sources 408, e.g., servers that may store and/or manage information associated with social media, weather information and other information about the locality. User profile information 410 is also obtained.

At 412, one or more hardware processors implementing a methodology of the present disclosure may estimate and combine risks, and outputs a ranked list of risks 418, for example, using a machine learning and/or statistics techniques.

At 414, one or more hardware processors implementing a methodology of the present disclosure may provide one or more recommendations 420.

At 416, a user may make a choice and provide feedback to the one or more hardware processors implementing a methodology of the present disclosure. At 422, the feedback and user choice may be stored in a user profile and used to improve the profile and provide more accurate risk estimation and recommendations.

In one embodiment, a real time user context (e.g., personalized) risk assessment method and system may estimate risk and make recommendations to a user based on multiple data sources, user profile and context. In one aspect, a user may check whether the geographic area or region or location is safe, for example, in various aspects, for example, for traveling, for example, for walking or parking. In one aspect, the system and methodology of the present disclosure in one embodiment may be invoked or utilized by an insurance company (e.g., travel, automobile, others) or another entity, for example, to send warning signals to customers, if for example, it is determined that risks exists or are predicted in the geographical locations. For instance, a short messaging system (SMS) warning may be sent about the area that is determined to have one or more risks, and direct the user to a different location that is determined to be safe. The geographic locations may include city, an area of a city, a specific parking area, specific road or street, and other regions, areas or locations. Risks may include safety concerns, e.g., due to weather such as flood risks, natural disaster, epidemic risks, and/or others.

Based on real-time risk determination, further actions may be taken, for example, reinforcing security in the regions. In one aspect, users who follow warning alerts (as determined from user decision and feedback information) may be made eligible for bonus, for example, by an insurance company. In another aspect, the alerts may signal an automobile and cause the automobile to steer away or drive in a different direction. For instance, an alert may be sent automatically to a control system that may control an automobile to automatically take a route to one or more of the recommended locations. In another aspect, an alert may be sent automatically to a navigation system or device associated with the automobile. Responsive to receiving the alert, the navigation system may automatically output, e.g., via automated voice or display, a different route to one or more of the recommended location instead.

In another aspect, one or more automatic security reinforcement actions may be performed responsive to receiving an alert.

Yet in another aspect, visual or graphical representation of the geographical area with the estimated information may be provided and presented, for example, on a graphical display device.

The methodology of the present disclosure may also improve a geographical information system (GIS) or technology, a system designed to capture, store, manipulate, analyze, manage, and present types of spatial or geographical data, for instance, by adding a feature that allows the GIS system for determine or estimate dynamic information about a geographic location.

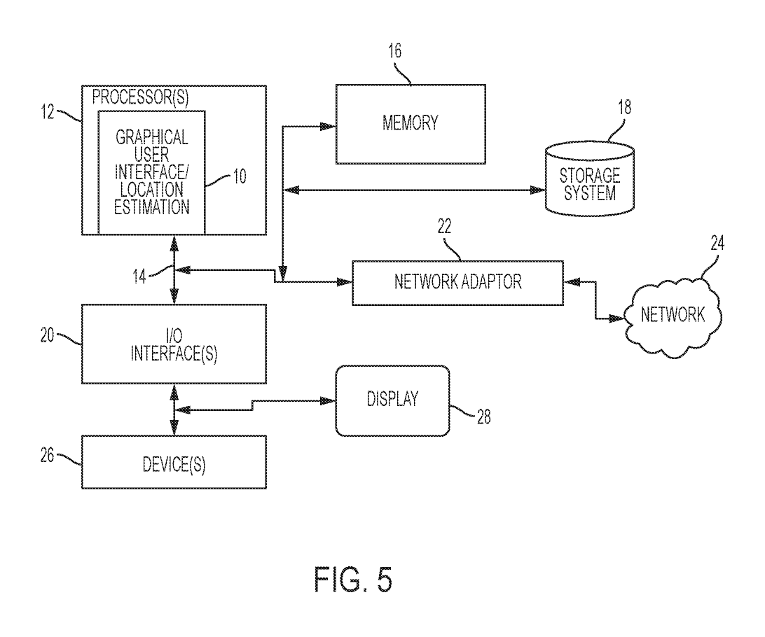

FIG. 5 illustrates a schematic of an example computer or processing system that may implement a context-aware location estimation system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method of estimating context aware information associated with a geographical location, comprising:
receiving information associated with the geographical location from a plurality of different data sources, the plurality of different data sources comprising at least a sensor from internet of things network monitoring in real-time information about the geographical location;
combining the information with social media input received via a social media server in real-time;
receiving a user profile of a user;
determining user context;
executing a machine learning algorithm to determine a plurality of risks associated with the geographic location to the user based on the user context, the user context comprising at least whether the user is in a vehicle and a type of vehicle the user is currently in, responsive to determining that the user is in a vehicle, the plurality of risks associated with the geographic location are determined based on at least whether the type of vehicle the user is currently in would have a problem in the geographic location, wherein different types of vehicles are determined to have different risks, the user context further comprising at least whether the user is walking, and responsive to determining that the user is walking, the plurality of risks are determined based on travel safety of walking in the geographic location;
presenting a ranked list of the plurality of risks;
recommending at least one alternative location;
determining feedback information as to whether or not the user acted on the alternative location and user's input as to whether the recommending was correctly based; and
storing the feedback information in the user profile, the user profile that is updated with the feedback information reused to provide next recommendation
responsive to determining that the user is in a vehicle, transmitting a signal to the vehicle to automatically control the vehicle to steer away from the geographic location.

2. (canceled)

3. The method of claim 1, further comprising:
sending a real-time alert to the user responsive to determining the plurality of risks.

4. (canceled)

5. The method of claim 1, wherein the method is performed responsive to receiving a request from the user.

6. The method of claim 1, wherein the method is performed while automatically monitoring with user's permission, the user traveling to the geographic location.

7. A non-transitory computer readable storage medium storing a program of instructions executable by a machine to perform a method of estimating context aware information associated with a geographical location, the method comprising:
receiving information associated with the geographical location from a plurality of different data sources , the plurality of different data sources comprising at least a sensor from internet of things network monitoring in real-time information about the geographical location;
combining the information with social media input received via a social media server in real-time;
receiving a user profile of a user;
determining user context;
executing a machine learning algorithm to determine a plurality of risks associated with the geographic location to the user based on the user context, the user context comprising at least whether the user is in a vehicle and a type of vehicle the user is currently in, responsive to determining that the user is in a vehicle, the plurality of risks associated with the geographic location are determined based on at least whether the type of vehicle the user is currently in would have a problem in the geographic location, wherein different types of vehicles are determined to have different risks, the user context further comprising at least whether the user is walking, and responsive to determining that the user is walking, the plurality of risks are determined based on travel safety of walking in the geographic location;
presenting a ranked list of the plurality of risks;
recommending at least one alternative location;
determining feedback information as to whether or not the user acted on the alternative location and user's input as to whether the recommending was correctly based; and
storing the feedback information in the user profile, the user profile that is updated with the feedback information is reused to provide next recommendation,
responsive to determining that the user is in a vehicle, transmitting a signal to the vehicle to automatically control the vehicle to steer away from the geographic location.

8. (canceled)

9. The non-transitory computer readable storage medium of claim 7, further comprising:
sending a real-time alert to the user responsive to determining the plurality of risks.

10. (canceled)

11. The non-transitory computer readable storage medium of claim 7, wherein the method is performed responsive to receiving a request from the user.

12. The non-transitory computer readable storage medium of claim 7, wherein the method is performed while automatically monitoring with user's permission, the user traveling to the geographic location.

13. A system of estimating context aware information associated with a geographical location, comprising:
one or more hardware processors;
one or more of the hardware processors operable to receive information associated with the geographical location from a plurality of different data sources , the plurality of different data sources comprising at least a sensor from Internet of things network monitoring in real-time information about the geographical location,
one or more of the hardware processors further operable to combine the information with social media input received via a social media server in real-time,
one or more of the hardware processors further operable to determine user context,
one or more of the hardware processors further operable to executing a machine learning algorithm to determine a plurality of risks associated with the geographic location to the user based on the user context, the user context comprising at least whether the user is in a vehicle and a type of vehicle the user is currently in, responsive to determining that the user is in a vehicle, the plurality of risks associated with the geographic location are determined based on at least whether the type of vehicle the user is currently in would have a problem in the geographic location, wherein different types of vehicles are determined to have different risks, the user context further comprising at least whether the user is walking, and responsive to determining that the user is walking, the plurality of risks are determined based on travel safety of walking in the geographic location,
one or more of the hardware processors further operable to present a ranked list of the plurality of risks; and
a storage device storing a user profile;
one or more of the hardware processors further operable to recommend at least one alternative location, determine feedback information as to whether or not the user acted on the alternative location and user's input as to whether the recommending was correctly based, and store the feedback information in the user profile, the user profile that is updated with the feedback information reused to provide next recommendation,
responsive to determining that the user is in a vehicle, one or more of the hardware processors further operable to transmit a signal to the vehicle to automatically control the vehicle to steer away from the geographic location.

14. (canceled)

15. The system of claim 13, wherein one or more of the hardware processors are further operable to send a real-time alert to the user responsive to determining the plurality of risks.

16. (canceled)

17. The method of claim 1, further comprising communicating the alternate location to a navigation system coupled to an automobile associated with the user context and causing the navigation system to output an automated voice activated alert and display of the alternate location.

18. The non-transitory computer readable storage medium of claim 7, wherein the method further comprises communicating the alternate location to a navigation system coupled to an automobile associated with the user context and causing the navigation system to output an automated voice activated alert and display of the alternate location.

19. The system of claim 13, wherein one or more of the hardware processors are further operable to communicate the alternate location to a navigation system coupled to an automobile associated with the user context and causing the navigation system to output an automated voice activated alert and display of the alternate location.

20. The method of claim 1, wherein the user context further comprises whether the user is attempting to park the vehicle at the geographic location, and responsive to determining that the user is attempting to park the vehicle, the plurality of risks are determined based on parking safety in the geographic location.
